(19) United States
(12) Patent Application Publication
(10) Pub. No.: US 2010/0185570 A1
(43) Pub. Date: Jul. 22, 2010

(54) THREE-DIMENSIONAL MOTION IDENTIFYING METHOD AND SYSTEM

(75) Inventor: Chun-Liang Ou, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTeK COMPUTER INC., Taipei (TW)

(21) Appl. No.: 12/647,547

(22) Filed: Dec. 28, 2009

(30) Foreign Application Priority Data
Jan. 22, 2009 (TW) 98102579

(51) Int. Cl. G06F 15/18; G01P 15/00; G06N 5/02; G06F 17/30

(52) U.S. Cl. 706/12; 702/141; 706/54; 707/E17.014; 707/802; 707/E17.044; 707/758

(57) ABSTRACT

A three-dimensional (3D) motion identifying method and system are used for identifying a motion of an object in a 3D space. First, the method provides a database recording sets of predetermined inertial information, and each of the sets of predetermined inertial information is an inertial movement of a specific motion in the 3D space. Then, inertial information of the object in moving is retrieved via a motion sensor in the object, and the inertial information is compared with all predetermined inertial information in the database to determine similarities therebetween. Finally, whether the motion of the object is the same as any predetermined inertial information or not is determined according to a degree of the similarity. As a result, more complicated motions of the object can be directly identified via the comparison with the database.

### CROSS-REFERENCE TO RELATED APPLICATION

This application claims the priority benefit of Taiwan application serial no. 98102579, filed Jan. 22, 2009. The entirety of the above-mentioned patent application is hereby incorporated by reference herein and made a part of specification.

### BACKGROUND OF THE INVENTION

1. Field of the Invention

The invention relates to a motion identifying method and, more particularly, to a method and system for indentifying the motion of an object in a three-dimensional (3D) space.

2. Description of the Related Art

Generally speaking, a user using a computer system may utilize common input devices such as a keyboard or a mouse to operate application programs or activate functions. Additionally, when some specific software (such as game software) is executed, the usage of motion sensing rocker can help the user to more intuitively and conveniently achieve a human computer interaction requirement.

A common design of the motion sensing rocker is that after a user operates the motion sensing rocker, a sensor needs to obtain inertial information such as acceleration in every axis generated via the movement of the rocker, and then a maximal acceleration value of the acceleration values in all axis is utilized as a basis to determine motions of the rocker. For example, when the acceleration of the inertial information toward left is far larger than the acceleration toward other directions, a sensor determines that the user holds the rocker and waves toward left. In other words, presently, a trend of the inertial information must be analyzed to determine the motion of the rocker.

To make an analogy with an eight-direction operation of a common mechanical type rocker, companies pre-build a series of basic motion modes such as the basic motion modes waving toward “up”, “down”, “left”, “right”, “upper left”, “lower left”, “upper right”, and “lower right” according to the trend condition of the inertial information. As for identifications of some complicated motions, after the user operates the rocker, the sensor firstly determines which basic motion modes an operation includes, and then the complicated motion is determined according to a combination motion. For example, the motion of the rocker waved by the user to draw a “y” symbol is determined to be the combination of two basic motion modes, waving toward “down” and “upper right”.

However, in this design, kinds of motions which can be identified have to be set in firmware of the rocker in advance. As a result, the corresponding functions can be activated only when the motions of the rocker are in accord with predefined motions, and other motions cannot produce any operation effect. That is, the user only can operate the computer system via built-in basic motion modes or the combination of the basic motion modes. Limited numbers of motion kinds makes the operation of the rocker have less elastic. Thus, a usage convenience is greatly reduced.

### BRIEF SUMMARY OF THE INVENTION

The invention provides a 3D motion identifying method. The 3D motion identifying method directly identifies motions that an object produces in a 3D space via a comparison with the database.

The invention provides a 3D motion identifying system. With the 3D motion identifying system, a user can build inertial information of a predetermine motion of the database according to his or her demand to provide an elasticity of adding kinds of motions which can be identified. Furthermore, the invention provides a studying mode to allow the inertial information of the predetermine motion to be slightly adjusted along with a motion habit of the user to improve a rate of motion identification.

The invention provides a 3D motion identifying method used for identifying a motion of the object in the 3D space. First, a database recording sets of predetermined inertial information is provided, and each of the sets of predetermined inertial information is an inertial movement of a specific motion in the 3D space. Afterwards, inertial information of the object in moving is retrieved via a motion sensor in the object, and a similarity is compared between the inertial information and each of the sets of predetermined inertial information in the database. Finally, whether a motion of the object is the same as the specific motion corresponding to one of the sets of predetermined inertial information is determined according to the similarities.

According to an embodiment of the invention, the motion sensor continually retrieves the inertial information of the object. The step of retrieving the inertial information of the object in moving includes the following step. First, a beginning time and a finishing time of the motion of the object are determined. Then, all the inertial information between the beginning time and the finishing time is retained.

According to an embodiment of the invention, a state of the object is predetermined to a stationary state, and the step of determining the beginning time and the finishing time of the motion of the object includes the following steps. When the state of the object is the stationary state, a time point at which the inertial information of the object is greater than or equal to a first predetermined value is utilized as the beginning time, and the state of the object is updated to a motion state. Then, when the state of the object is the motion state, the time point at which the inertial information of the object is smaller than the first predetermined value for a specific time is utilized as the finishing time, and the state of the object is updated to the stationary state.

According to an embodiment of the invention, the motion sensor includes one of a G-sensor and a Gyro sensor, and the inertial information includes one of a velocity, acceleration, an angular velocity, and displacement.

According to an embodiment of the invention, the database records at least a command and a corresponding relationship between each of the commands and at least one set of the predetermined inertial information.

According to an embodiment of the invention, after the step of determining whether the motion of the object is the same as the specific motion corresponding to any predetermined inertial information according to the similarities, the 3D motion identifying method further includes the step that the command corresponding to one of the sets of the predetermined inertial information having the highest similarity is triggered to perform a function.

According to an embodiment of the invention, the 3D motion identifying method further includes the following steps. First, a database building model is entered. Second, the inertial information of the object in moving is obtained via the motion sensor. Third, the inertial information is recorded in the database as a set of the predetermined inertial information. Fourth, a command is obtained. Fifth, the corresponding relationship between the inertial information and the command is built in the database. The inertial information is the specific motion of the object operated by a user the object in the 3D space.

According to an embodiment of the invention, the step of obtaining the command further includes a step that the command recorded in the database or inputted by a user is obtained.

According to an embodiment of the invention, the 3D motion identifying method further includes the following steps. First, a motion study mode is entered. Second, a set of the predetermined inertial information is chosen as reference inertial information. Third, the inertial information of the object in moving is retrieved via the motion sensor. Fourth, the inertial information and the reference inertial information are compared to obtain the similarity between the inertial information and the reference inertial information. Fifth, when the similarity is between a first value and a second value, the reference inertial information is modified according to the inertial information, and the method returns to the step of retrieving the inertial information of the object in moving via the motion sensor to reobtain the similarity, and when the similarity is smaller than the second value, the method returns to the step of retrieving the inertial information of the object in moving via the motion sensor to reobtain the similarity. The first value is larger than the second value.

According to another aspect, the invention further provides a 3D motion identifying system. The 3D motion identifying system includes a database, a motion sensor, and a processing module. The database used for recording sets of the predetermined inertial information. Each of the sets of predetermined inertial information is an inertial movement of a specific motion in the 3D space. The motion sensor is used for obtaining inertial information of an object when the object moves in the 3D space. The processing module coupled with the database and the motion sensor, respectively. The processing module is used for comparing a similarity between the inertial information and each of the sets of predetermined inertial information in the database and determining whether a motion of the object is the same as the specific motion corresponding to one of the sets of predetermined inertial information according to the similarities.

According to an embodiment of the invention, the motion sensor continually retrieves the inertial information of the object, and the processing module determines the beginning time and the finishing time of the motion of the object to retain all the inertial information between the beginning time and the finishing time.

According to an embodiment of the invention, the state of the object is predetermined to be a stationary state. When the state of the object is the stationary state, the processing module utilizes a time point at which the inertial information of the object is greater than or equal to a first predetermined value as the beginning time and updates the state of the object to a motion state. When the state of the object is the motion state, the processing module utilizes the time point at which the inertial information of the object is smaller than the first predetermined value for a specific time as the finishing time and updates the state of the object to the stationary state.

According to an embodiment of the invention, the motion sensor includes one of a G-sensor and a Gyro sensor, and the inertial information includes one of a velocity, acceleration, an angular velocity, and displacement.

According to an embodiment of the invention, the database records at least a command and a corresponding relationship between each of the command and at least one set of the predetermined inertial information.

According to an embodiment of the invention, the processing module triggers the command corresponding to the predetermined inertial information having the highest similarity to perform a function.

According to an embodiment of the invention, in a database building model, the processing module retrieves the inertial information of the object in moving obtained by the motion sensor, records the inertial information in the database to utilize the inertial information in the database as a set of the predetermined inertial information, and obtains a command to establish the corresponding relationship between the inertial information and the command in the database. The inertial information is the specific motion of the object operated by a user the object in the 3D space.

According to an embodiment of the invention, the processing module obtains the command recorded in the database or inputted by a user.

According to an embodiment of the invention, in a motion study mode, the processing module chooses a set of the predetermined inertial information as a reference inertial information, retrieves the inertial information of the object in moving via the motion sensor, and compares the inertial information and the reference inertial information to obtain the similarity between the inertial information and the reference inertial information. When the similarity is between a first value and a second value, the processing module modifies the reference inertial information according to the inertial information, and re-retrieves the inertial information of the object in moving via the motion sensor to reobtain the similarity. When the similarity is less than the second value, the inertial information of the object in moving is re-retrieved via the motion sensor to reobtain the similarity. The first value is larger than the second value.

As stated above, when the invention determines the motion of the object in the 3D space, the inertial information produced by the motion of the object is directly compared with all predetermined inertial information in the database to identify different complicated motions of the object. The predetermined inertial information recorded in the database may be built by a user himself or herself Furthermore, the predetermined inertial information can be slightly adjusted according to a habit of a user that he or she operates the object to improve elastic of the database. Thus, identification of motions of the object becomes more effective.

These and other features, aspects and advantages of the present invention will become better understood with regard to the following description, appended claims, and accompanying drawings.

### BRIEF DESCRIPTION OF THE DRAWINGS

FIG. 1 is a block diagram showing a 3D motion identifying system according to an embodiment of the invention;

FIG. 2 is a flow chart showing a 3D motion identifying method according to an embodiment of the invention;

FIG. 3 is a flow chart showing steps of building a database according to an embodiment of the invention; and

FIG. 4 is a flow chart showing steps of a motion study according to an embodiment of the invention.

### DETAILED DESCRIPTION OF THE EMBODIMENTS

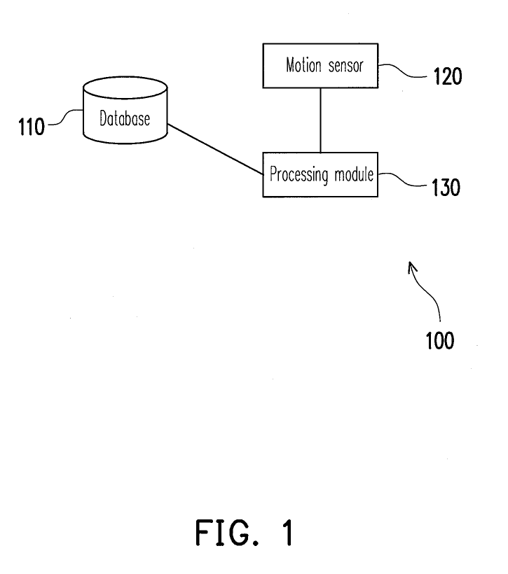

FIG. 1 is a block diagram showing a 3D motion identifying system according to an embodiment of the invention. A 3D motion identifying system 100 includes a database 110, a motion sensor 120, and a processing module 130. The 3D motion identifying system 100 may be used for identifying a motion of an object in a 3D space. In this embodiment, an identified object may be a rocker, a remote controller or any other devices. To facilitate description, the object is supposed to be the rocker in embodiments hereafter. The 3D motion identifying system 100 can identify the motions of the rocker operated by the user. Functions of elements of the 3D motion identifying system 100 are described hereafter.

The database 110 records sets of predetermined inertial information therein. The predetermined inertial information may be predetermined information of the 3D motion identifying system 100 or information built by the user himself or herself. Each set of predetermined inertial information may be one of or a combination of a velocity, acceleration, an angular velocity, and displacement to describe an inertial movement of a specific motion in the 3D space. In this embodiment, the database 110 further records a plurality of commands and a corresponding relationship between each command and at least one set of the predetermined inertial information. In other words, the command in the database 100 may be corresponding to more than one set of predetermined inertial information. However, a set of predetermined inertial information only can be corresponding to one command.

The motion sensor 120 may be devices such as a G-sensor or a Gyro sensor which can retrieve the inertial information of the rocker in moving in the 3D space motion. In this embodiment, the motion sensor 120 is disposed in the rocker. When the user holds the rocker and operates it, the motion sensor 120 can detect the inertial information such as the velocity, the acceleration, the angular velocity, and the displacement generated via the motions of the rocker.

The processing module 130 may be hardware or software having computing and processing functions or a combination of them. After the inertial information retrieved by the motion sensor 120 is obtained, the inertial information and all the sets of the predetermined inertial information in the database 110 are compared to obtain corresponding similarities. As a result, according to the similarities, whether the motion of the object is the same as the specific motion corresponding to one set of predetermined inertial information is determined. In an embodiment, the processing module 130 may be disposed in the computer system. The processing module 130 obtains the inertial information that the motion sensor 120 obtains via transmission interfaces such as Bluetooth or a universal serial bus (USB). In another embodiment, the processing module 130 may be disposed in the rocker to directly identify the motions of the rocker.

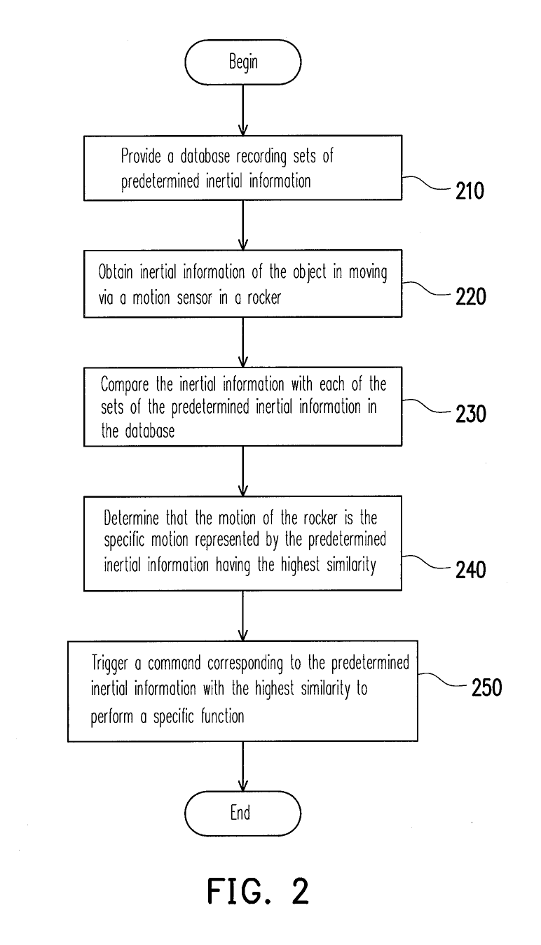

A detailed operational flow path of the 3D motion identifying system 100 is described hereafter to further explain the invention. FIG. 2 is a flow chart showing a 3D motion identifying method according to an embodiment of the invention. First, as shown in step 210, the database 110 recording sets of the predetermined inertial information is provided. In this embodiment, the database 110 further records a plurality of commands and corresponding relationships between each of the commands and the predetermined inertial information.

Then, in step 220, inertial information of the object in moving is retrieved via a motion sensor in the rocker. In this embodiment, no matter whether the rocker moves or not, the motion sensor 120 continually retrieves the inertial information of the rocker and transmits the inertial information to the processing module 130. The processing module determines a beginning time and a finishing time of the rocker in moving to retain the inertial information between the beginning time and the finishing time. Further, in this embodiment, the state of the rocker is predetermined to be a stationary state. When the state of the rocker is the stationary state, the processing module 130 determines that the rocker begins to move at a time point when the inertial information of the rocker is greater than or equal to than a first predetermined value, the processing module 130 utilizes the time point as a beginning time when the motion starts, and it updates the state of the rocker to a motion state. Once the rocker enters the motion state, the processing module 130 determines that the rocker stops moving at the point when the inertial information of the rocker is smaller than the first predetermined value for a specific time, it utilizes the time point as the finishing time of the motion and updates the state of the rocker to the stationary state. The processing module 130 only takes the inertial information retrieved by the motion sensor 120 between the beginning time and the finishing time as the inertial information of the rocker in moving.

Afterwards, as shown in step 230, the processing module 130 compares the inertial information of the rocker in moving with each of the sets of predetermined inertial information in the database 110 to obtain the similarities between the inertial information and the predetermined inertial information in the database. Since each of the sets of predetermined inertial information represents different specific motions, respectively, and the inertial information of the motion of the rocker may represent the motions of the rocker operated by the user, a degree of the similarities between the predetermined inertial information and the inertial information can be utilized as a basis to determine the motions.

That is, the processing module 130 determines whether the motion of the object is the same as the specific motion corresponding to the predetermined inertial information in the database according to the similarity. In this embodiment, as shown in step 240, the processing module 130 determines that the motion of the rocker is the specific motion represented by the predetermined inertial information having the highest similarity.

Finally, in step 250, the processing module 130 triggers the command corresponding to the predetermined inertial information with the highest similarity to perform a corresponding specific function. In this embodiment, the kinds of functions triggered by the commands are not limited. For example, if the command corresponding to a first set of the predetermined inertial information in the database 110 can activate a multimedia play program in the computer system, when the motion of the rocker operated by the user is the same as the specific motion represented by the first set of the predetermined inertial information, the processing module 130 triggers the command to execute the multimedia play program.

In the above embodiments, the predetermined inertial information used for representing and describing the specific motions is prestored in the database 110. When the user operates the rocker to allow the rocker to produce the motion, the processing module 130 can compare the inertial information retrieved by the motion sensor 120 with the predetermined inertial information in the database 110, and it further identifies the motion of the rocker according to the degree of the similarities between the inertial information and sets of the predetermined inertial information.

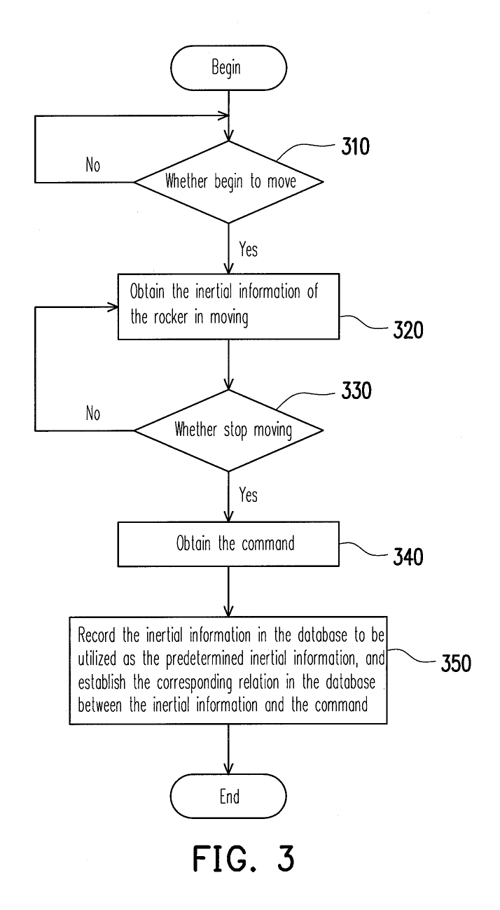

In this embodiment, the user can define the predetermined inertial information in the database 110 by himself or herself via the operation of the rocker. FIG. 3 is a flow chart showing steps of building a database according to an embodiment of the invention. After the 3D motion identifying system 100 enters a database building model, the state of the rocker is predetermined to be the stationary state. As shown in step 310, since the motion sensor 120 in the rocker continually retrieves the inertial information of the rocker, the processing module 130 repeatedly determines whether the rocker begins to move according to whether the inertial information is greater than or equal to the first predetermined value. If the inertial information of the rocker is greater than or equal to the first predetermined value, which represent that the rocker begins to move, in step 320, the processing module 130 obtains the inertial information of the rocker in moving retrieved by the motion sensor 120. Then, in step 330, the processing module 130 determines whether the rocker stops moving according to whether the inertial information is smaller than the first predetermined value for the specific time. If the inertial information is still larger than the first predetermined value, which represents that the rocker still moves, the processing module 130 returns to perform step 320 to obtain the inertial information obtained by the motion sensor 120 until the processing module 130 determines that the rocker stops moving. Afterwards, in step 340, the processing module 130 obtains a command. The command may be recorded in the database 110 or inputted by a user. Finally, as shown in step 350, the processing module 130 records the inertial information of the rocker in moving in the database 110 to be utilized as a set of the predetermined inertial information, and it establishes the corresponding relation between the inertial information and the command in the database 110.

The computer system operated via the rocker is taken as an example. If the user wants to activate a web browser program of the computer system when he or she waves the rocker and draws a “β” symbol, the user has to make the 3D motion identifying system 100 enter the database building model in advance. Modes of entering the 3D motion identifying system 100 into the database building model are not limited. Then, the user waves the rocker to draw the “β” symbol. After the user confirms the motion is correct, the processing module 130 records the inertial information representing the specific motion that the rocker draws the “β” symbol in the database 110, and it establishes the corresponding relation between the inertial information and the web browser program activating command in the database 110. Afterwards, as long as the user waves the rocker and draws the “β” symbol, the web browser program can be activated in the computer system.

In the above embodiments, when the user defines the predetermined inertial information of the database 110 by himself or herself, the inertial information of the motion with which the user draws the “β” symbol twice also may be corresponding to the web browser program activating command. As a result, a probability that the command cannot be triggered to perform the function due to a small variance produced when the user operates the rocker can be reduced. Additionally, the user can make absolute different motions (For example, the rocker is used to draw the “α” symbol or and the “β” symbol) of the rocker corresponding to the same command to improve richness of the motion triggering the same function.

As stated in the above embodiments, the user can increase or modify the predetermined inertial information and the corresponding command in the database 110 at any'time according to his or her demands. As a result, the motions of the rocker which can trigger the command to perform the specific function are not limited. To the user, it is more flexible and elastic to perform the function via the operation of the rocker.

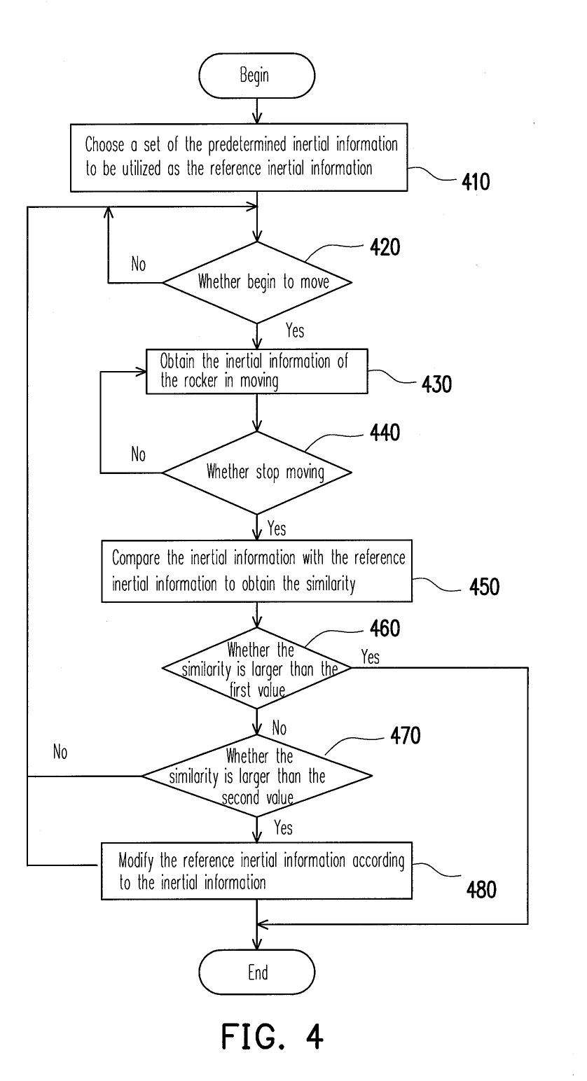

To allow the user to study the specific motions represented by the predetermined inertial information in the database 110, when the 3D motion identifying system 100 enters the motion study mode, it demands the user to choose a set of the predetermined inertial information to be utilized as the reference inertial information and allows the user to study the specific motion represented by the reference inertial information. The modes of entering the 3D motion identifying system 100 into the motion study mode are not limited herein. FIG. 4 is a flow chart showing steps of a motion study according to an embodiment of the invention. First, in step 410, the processing module 130 chooses a set of the predetermined inertial information in the database 110 to be utilized as the reference inertial information according to an instruction of the user.

Afterwards, in step 420 to step 440, the processing module 130 obtains the inertial information of the rocker in moving retrieved by the motion sensor 120. Since the mode in which the processing module 130 determines whether the rocker begins to move or stops moving is the same as or similar to that of the above embodiments, so the mode is not described herein for a concise purpose. After the inertial information of the rocker in moving is obtained, as shown in step 450, the processing module 130 compares the inertial information with the reference inertial information to obtain the similarity therebtween.

Then, in step 460, the processing module 130 determines whether the similarity is larger than the first value. If the similarity is larger than the first value, which represents that the motion of the rocker operated by the user and the specific motion represented by the reference inertial information are very similar. Thus, the motion study flow is end.

However, if the similarity is smaller than the first value, then, in step 470, the processing module 130 determines whether the similarity is larger than the second value (the second value is smaller than the first value). If the similarity is larger than the second value, which represents that a difference between the motion of the user and the specific motion represented by the inertial information is in an acceptable range although the difference exits. Consequently, as shown in step 480, the processing module 130 modifies the reference inertial information according to the inertial information. As a result, the predetermined inertial information in the database 110 can be slightly adjusted along with a motion habit of the user to improve a reproduction rate of the motion. Then, the motion study flow path returns to step 420 in which the user is demanded to hold the rocker to do the same motion operate to obtain the similarity. However, in step 470, if the processing module 130 determines that the similarity is smaller than the second value, which represents that the difference between the motion of the user and the specific motion represented by the inertial information is very larger, the user has to study the specific motion represented by the reference inertial information. As a result, the motion study flow returns to step 420 again to obtain the inertial information via the motion sensor 110 when the user operates the rocker to redetermine the similarity between the inertial information and the reference inertial information. For example, the processing module 130 reminds the user that how to operate the rocker is more approximate to the specific motion represented by the reference inertial information according to the difference between the inertial information and the reference inertial information. In this embodiment, the motion study flow continually circulates until the similarity between the motion of the rocker operated by the user and the reference inertial information is larger than the first value.

As shown in the motion study flow in FIG. 4, the user does not need to accurately adapt to the specific motions represented by the predetermined inertial information in the database 110. Conversely, in the motion study mode, the predetermined inertial information can be partly adjusted cooperating with the motion of the user to make the adjusted predetermined inertial information be more in accord with motion habits of the user.

As stated above, the 3D motion identifying method and system according to the invention provide a database. The database records sets of predetermined inertial information. After the inertial information produced by the motion of the object operated by a user is retrieved, the inertial information is compared with the predetermined inertial information in the database. Then, the motion of the object is determined to perform a corresponding function according to the degree of the similarity. Furthermore, the user can add the predetermined inertial information to the database, and the predetermined inertial information can be slightly modified according to the habit of the user. As a result, the identification of the motion of the object is more elastic, and thus the correctness of performing a corresponding function after identifying the motion of the object is improved.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A three-dimensional (3D) motion identifying method, used for identifying a motion of an object in a 3D space, comprising:
providing a database, wherein the database records multiple sets of predetermined inertial information, and each of the sets of predetermined inertial information is an inertial movement of a specific motion in the 3D space;
retrieving a inertial information of the object in moving via a motion sensor in the object;
comparing a similarity between the inertial information and each of the sets of predetermined inertial information in the database; and
determining whether a motion of the object is the same as the specific motion corresponding to one of the sets of predetermined inertial information according to the similarities.

2. The 3D motion identifying method according to claim 1, wherein the motion sensor continually retrieves the inertial information of the object, the step of retrieving the inertial information of the object in moving comprises:
determining a beginning time and a finishing time of the motion of the object; an retaining all the inertial information between the beginning time and the finishing time.

3. The 3D motion identifying method according to claim 2, wherein the step of determining the beginning time and the finishing time of the motion of the object comprises:
determining a time point at which the inertial information of the object is greater than or equal to a first predetermined value as the beginning time and bring the object to a motion state from the stationary state; and
determining the time point at which the inertial information of the object is smaller than the first predetermined value for a specific time as the finishing time and bring the object to the stationary state from the motion state.

4. The 3D motion identifying method according to claim 1, wherein the motion sensor comprises one of a G-sensor and a Gyro sensor, and the inertial information comprises one of a velocity, acceleration, an angular velocity, and displacement.

5. The 3D motion identifying method according to claim 1, wherein the database records at least a command and a corresponding relationship between each of the commands and at least one of the predetermined inertial information.

6. The 3D motion identifying method according to claim 5, after the step of determining whether the motion of the object is the same as the specific motion corresponding to one of the sets of predetermined inertial information according to the similarities, further comprising:
triggering the command corresponding to the predetermined inertial information having the highest similarity to perform a function.

7. The 3D motion identifying method according to claim 1, further comprising:
entering a database building model;
obtaining the inertial information of the object in moving via the motion sensor, wherein the inertial information is the specific motion of the object operated by a user in the 3D space;
recording the inertial information in the database as a set of the predetermined inertial information;
obtaining a command; and
establishing the corresponding relationship between the inertial information and the command in the database.

8. The 3D motion identifying method according to claim 7, wherein the step of obtaining the command further comprises:
obtaining the command recorded in the database or inputted by a user.

9. The 3D motion identifying method according to claim 1, further comprising:
entering a motion study mode;
choosing a set of the predetermined inertial information as a reference inertial information;
retrieving the inertial information of the object in moving via the motion sensor;
comparing the inertial information and the reference inertial information to obtain the similarity between the inertial information and the reference inertial information;
when the similarity is between a first value and a second value, modifying the reference inertial information according to the inertial information and returning to the step of retrieving the inertial information of the object in moving via the motion sensor to re-obtain the similarity, wherein the first value is larger than the second value; and
returning to the step of retrieving the inertial information of the object in moving via the motion sensor to re-obtain the similarity when the similarity is smaller than the second value.

10. A 3D motion identifying system, comprising:
a database used for recording sets of predetermined inertial information, wherein each of the sets of predetermined inertial information is an inertial movement of a specific motion in a 3D space;
a motion sensor used for retrieving inertial information of an object when the object moves in the 3D space, and
a processing module coupled with the database and the motion sensor and used for comparing a similarity between the inertial information and each of the sets of predetermined inertial information in the database, respectively, and determining whether a motion of the object is the same as the specific motion corresponding to one of the sets of predetermined inertial information according to the similarities.

11. The 3D motion identifying system according to claim 10, wherein the motion sensor continually retrieves the inertial information of the object, and the processing module determines the beginning time and the finishing time of the motion of the object to retain all the inertial information between the beginning time and the finishing time.

12. The 3D motion identifying system according to claim 11, wherein the state of the object is predetermined to be a stationary state, when the state of the object is the stationary state, the processing module utilizes a time point at which the inertial information of the object is greater than or equal to a first predetermined value as the beginning time and updates the state of the object to a motion state, and when the state of the object is the motion state, the processing module utilizes the time point at which the inertial information of the object is smaller than the first predetermined value for a specific time as the finishing time and updates the state of the object to the stationary state.

13. The 3D motion identifying system according to claim 10, wherein the motion sensor comprises one of a G-sensor and a Gyro sensor, and the inertial information comprises one of a velocity, acceleration, an angular velocity, and displacement.

14. The 3D motion identifying system according to claim 10, wherein the database records at least a command and a corresponding relationship between each of the commands and at least one set of the predetermined inertial information.

15. The 3D motion identifying system according to claim 14, wherein the processing module triggers the command corresponding to the predetermined inertial information having the highest similarity to perform a function.

16. The 3D motion identifying system according to claim 10, wherein in a database building model, the processing module retrieves the inertial information of the object in moving obtained by the motion sensor, records the inertial information in the database as a set of the predetermined inertial information, obtains a command to establish the corresponding relationship between the inertial information and the command in the database, and the inertial information is the specific motion of the object operated by a user in the 3D space.

17. The 3D motion identifying system according to claim 16, wherein the processing module obtains the command recorded in the database or inputted by a user.

18. The 3D motion identifying system according to claim 10, wherein in a motion study mode, the processing module chooses a set of the predetermined inertial information as a reference inertial information, retrieves the inertial information of the object in moving via the motion sensor, and compares the inertial information and the reference inertial information to obtain the similarity between the inertial information and the reference inertial information, when the similarity is between a first value and a second value, the processing module modifies the reference inertial information according to the inertial information, re-retrieved the inertial information of the object in moving via the motion sensor to reobtain the similarity, when the similarity is less than the second value, the inertial information of the object in moving is re-retrieved via the motion sensor to reobtain the similarity, and the first value is larger than the second value.
